(19) United States
(12) Patent Application Publication
(10) Pub. No.: US 2009/0104582 A1
(43) Pub. Date: Apr. 23, 2009

(54) Male threaded implant drill

(76) Inventor: Gary Allan Duncan, Dublin, OH (US)

Correspondence Address: Mr. Gary A. Duncan, 8831 Locherbie Court, Dublin, OH, 43017, US

(21) Appl. No.: 11/975,586

(22) Filed: Oct. 22, 2007

(51) Int. Cl. A61C 8/00

(52) U.S. Cl. 433/173

(57) ABSTRACT

The Male Threaded Implant Drill will assist in the process that will allow a surgeon to place a dental implant in the mandible and/or maxilla bone(s) while working in conjunction with a stent. The Male Threaded Implant Drill is used in the placement of a surgical dental implant perfectly parallel to other dental implant(s) and root structures. The Implant Drill is used in conjunction with a surgical dental implant stent that will allow a surgeon to place dental implant(s) at a predetermined depth within the mandible and/or maxilla of a patient undergoing surgery.

### CROSS-REFERENCE TO RELATED APPLICATIONS

U.S. Ser. No. 11/80,366, U.S. Ser. No. 11/807,360, U.S. Ser. No. 11/807,377. The stated application numbers benefit the Male Threaded Implant Drill as collectively they are used in manufacturing a dental implant stent that is used in conjunction with this product.

### STATEMENT REGARDING FEDERALLY SPONSORED RESEARCH OR DEVELOPMENT

Not Applicable

### REFERENCE TO SEQUENCE, A TABLE, OR A COMPUTER PROGRAM LISTING COMPACT DISK APPENDIX

Not Applicable

### BACKGROUND OF THE INVENTION

The Male Threaded Implant Drill is placed into use during a sequence of steps in conjunction with a surgical dental implant stent and is suggested to be placed under Class 433, Dentistry, as this class is a specific class under the broader class of Surgery and includes methods directed to or including specific dental steps whereas the use of this device ultimately facilitates the replacement of teeth. The Male Threaded Implant Drill is suggested to be assigned the Subclass 25, Apparatus, whereas this device or subcombination thereof is for facilitating the replacement, treatment, or testing of either natural or artificial teeth noting that the above apparatus does not remain in the patient's mouth after treatment.

The Male Threaded Implant Drill is placed into use by creating a cavity in the maxilla and/or mandible of a dental implant patient as well as ultimately solving notable problems in the process of both favorably placing dental implants in a patients mouth using a stent. Because the Male Threaded Implant Drill or anything to serve its exact purpose while working in conjunction with a dental implant stent has not previously been invented, currently surgeons are unable to place a dental implant(s) parallel to other implant(s) or existing teeth on the arch of the mandible or maxilla of a patient undergoing surgery. When dental implants are not placed parallel to other dental implants, final restorations of prosthetic dental appliances are much more difficult to manufacture and the longevity of a final restoration is shortened. Without the Male Threaded Implant Drill and/or the process of its use with surgical dental implant stents, surgeons are unable to place a dental implant at an exact predetermined depth decided upon by the surgeon which allows the surgeon to immediately place after surgery the final prosthetic restoration in a patients mouth that will function in conjunction with dental implants previously placed in the mandible and/or maxilla bone(s). When surgeons have no means to accurately follow through with making a cavity to place a dental implant at a exact predetermined depth, such surgeons for example when making this cavity will pass through the bone of the mandible or maxilla and be required to find a new site as well as restore the damaged area causing additional time for a patient undergoing the procedure to heal and recover. However, more frequently surgeons create a cavity in a patient's maxilla or mandible and later place an implant in this same cavity that is at uneven depths and unparallel relative to other implants. Currently, surgically placed dental implant(s) are unable to facilitate the final restoration of a dental prosthetic device placed in a patient's mouth immediately after surgery.

### BRIEF SUMMARY OF THE INVENTION

The Male Threaded Implant Drill is placed into use during the process of physically creating a cavity in the maxilla or mandible of a patient undergoing dental implant surgery as well as ultimately solving notable problems in the process of both placing dental implants in a patients mouth at a predetermined depth and parallel to other implants and/or natural teeth using a stent. The Male Threaded Implant Drill is placed into use while creating a cavity in a patients mouth at a predetermined depth and parallel to other current or planned like cavities that will or do support a dental implant. The aforementioned is accomplished by placing the external male threads of the Male Threaded Implant Drill with the mating internal threads of the invention with the corresponding application number U.S. Ser. No. 11/807,366 or any device with internal screw threads that serves the same purpose as the invention with the corresponding application number U.S. Ser. No. 11/807,366, with a twisting/drilling motion. Because of the unique external male threads, the Male Threaded Implant Drill will mate with the internal female threads of the invention with the corresponding application number U.S. Ser. No. 11/807,366 which is a part of a dental implant stent that is surgically placed in a patient's mouth. The aforementioned stent is custom manufactured to allow the Male Threaded Implant Drill to pass only a predetermined depth into a patient's maxilla or mandible at only parallel spaces to other implants or natural teeth. The Male Threaded Implant Drill for the first time will allow a surgeon to control the depth of a cavity made to place dental implants in the mandible and/or maxilla bone(s) of a patient while also placing such dental implants parallel to other dental implants or teeth. The Male Threaded Implant Drill assists in this process that ultimately allows a final dental implant restoration to be placed in a patient's mouth immediately after surgery by working in conjunction with a dental implant stent.

The Male Threaded Implant Drill creates a cavity in the maxilla and/or mandible bone(s) of a patient receiving surgically placed dental implants by working in conjunction with a dental implant stent and therefore assists in allowing these dental implant(s) to be placed parallel and at predetermined depth allowing for increased longevity of a final restoration. The Male Threaded Implant Drill functions in conjunction with the aforementioned surgical dental implant stent because this (the stent) will serve as a guide by only allowing the Male Threaded Implant Drill to pass a predetermined measurable depth into the dental implant stent thus allowing a surgeon to place a dental implant at a predetermined depth in a patient's mandible and or maxilla bone(s) thus leaving no error for correct and desired dental implant placement.

### BRIEF DESCRIPTION OF THE SEVERAL OF THE DRAWING

FIG. 1 is a front view perspective of the Male Threaded Implant Drill;

FIG. 2 is a side view perspective of the Male Threaded Implant Drill.

### DETAILED DESCRIPTION OF THE INVENTION

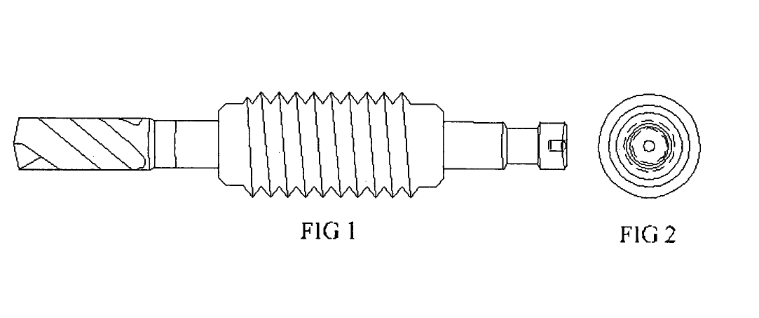

The Male Threaded Implant Drill is best carried out while used in conjunction with a dental implant stent placed by a surgeon in a patient's mouth. Referring to FIG. 1, the Male Threaded Implant Drill has machined external male threads located in the middle that will mate with internal female threads of the invention with application number U.S. Ser. No. 11/807,366. When placed into position of function, this invention has machined drill threads positioned distally while the opposite end contains a machined mate for a device to power the rotation of the drill.

Referring to FIG. 2, the Male Threaded Implant Drill is circular in design.

The Male Threaded Implant Drill is the first of it's kind and can be machined out of any surgical metal such as stainless steel or titanium while serving as the best way to carry out the manufacturing of this invention.

What is hereby claimed is:

1. In conjunction with a dental implant stent, a dental implant placement tool utilizing a dental implant stent that is surgically anchored into a patients mouth will create a cavity in the maxilla and/or mandible bone(s) that will then allow for the surgical placement of dental implant(s) in a patients mouth.

2. The dental implant placement tool defined in claim 1 will create a cavity in the maxilla and/or mandible bone(s) in the predetermined location of a surgeon.

3. The dental implant placement tool defined in claim 1 will create a cavity in the maxilla and/or mandible bone(s) at correct parallelism to other implants or root structures.

4. The dental implant placement tool defined in claim 1 will create a cavity in the maxilla and/or mandible bone(s) at depth within the maxilla and/or mandible bone(s) predetermined by a surgeon.

5. The dental implant tool defined in claim 1 will replace other dental implant placement systems that currently use or do not use stents.
